(19) United States
(12) Patent Application Publication
(10) Pub. No.: US 2014/0337727 A1
(43) Pub. Date: Nov. 13, 2014

(54) SYSTEM AND METHOD FOR DYNAMIC HELP CONTENT PRESENTATION

(71) Applicants: Manoharan G. Earurnthavadi, Bangalore (IN); Anand Kumar, Bangalore (IN); Muhammed Aslam PK, Kerala (IN); Lakshmi Krishna Jois, Bangalore (IN)

(72) Inventors: Manoharan G. Earurnthavadi, Bangalore (IN); Anand Kumar, Bangalore (IN); Muhammed Aslam PK, Kerala (IN); Lakshmi Krishna Jois, Bangalore (IN)

(73) Assignee: UNISYS CORPORATION, Blue Bell, PA (US)

(21) Appl. No.: 14/168,080

(22) Filed: Jan. 30, 2014

(30) Foreign Application Priority Data
May 10, 2013 (IN) 1405/DEL/2013

(51) Int. Cl. G06F 9/44; G06F 3/0481

(52) U.S. Cl. CPC G06F 9/4446; G06F 3/0481
USPC 715/708

(57) ABSTRACT

Systems and methods are disclosed herein to a method for presenting help content for a user interface comprising: displaying, by a computer, a user interface including a help tool window; receiving, by a computer, a request to display a first user interface page; referencing, by a computer, a first help content address of help content for the first user interface page that is stored in memory; changing, by a computer, a source attribute of the help tool window to the first help content address; and refreshing, by a computer, the help tool window so that the help content for the first user interface page is displayed by the help tool window.

### TECHNICAL HELD

The present invention relates generally to user interfaces, and more particularly to a method of presenting help content on a user interface.

### BACKGROUND

User interfaces that control applications running on computer systems may sometimes appear complex or daunting to a person unfamiliar with the user interface. To assist users, many computer applications include a help tool describing the functions of the application and how to use the user interface. More specifically, help tools describe the functions provided by the application and also how to command the application using the user interface.

Conventional help windows present help information according to a organizational method regardless of the current action of the user. For example, a first page may list categories of functions performed by the application. Conventional help windows may also include a search function to help a user find desired content. However, conventional help content windows require a user to find or search for the function with which they need assistance. Finding the correct help content requires searching or navigating through a hierarchy of categories. Finding the appropriate help content takes up valuable time of the user. Often users become frustrated when their search attempts are unsuccessful in finding their specific help topic.

Users demand easily accessible help content. More specifically, users demand help content that provides information about the process or function currently being viewed by the user. So, there is a need for help content that dynamically updates with the actions of the user so that a user can receive immediate assistance from the help content about processes and functions being used by the user.

### SUMMARY

The systems and methods described herein attempt to overcome the drawbacks discussed above by providing help content that dynamically updates with a user's navigation of a user interface. The help content updates whenever a user clicks or activates a function button or hyperlink. The help tool can be expandable and collapsible within the user interface by pressing an expand/collapse button.

In one embodiment, a method for presenting help content for a user interface comprises: displaying, by a computer, a user interface including a help tool window; receiving, by a computer, a request to display a first user interface page on the user interface; referencing, by a computer, a first help content address of help content for the first user interface page that is stored in memory; changing, by a computer, a source attribute of the help tool window to the first help content address; and refreshing, by a computer, the help tool window so that the help content for the first user interface page is displayed by the help tool window, wherein help content is based upon content of the first user interface page.

In another embodiment, a computer system comprises: a memory; and a processor configured to: display a user interface including a help tool window; receive a request to display a first user interface page on the user interface; reference a first help content address of help content for the first user interface page that is stored in the memory; change a source attribute of the help tool window to the first help content address; and refresh the help tool window so that the help content for the first user interface is displayed by the help tool window, wherein help content is based upon content of the first user interface page.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a computer system for presenting a user interface that includes a context-sensitive help tool to a client device according to an exemplary embodiment.

FIG. 2 illustrates a screen shot of the user interface with a collapsed help tool according to an exemplary embodiment.

FIG. 3 illustrates a screen shot of the user interface with an expanded help tool presenting help content for a first page according to an exemplary embodiment.

FIG. 4 illustrates a screen shot of the user interface with the expanded help tool presenting help content for a second page according to an exemplary embodiment.

FIG. 5 illustrates a method for dynamically presenting help content in an expandable help tool according to an exemplary embodiment.

FIG. 6 illustrates a method for dynamically presenting help content in a collapsible help tool according to an exemplary embodiment.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments may be substituted for the particular examples described herein and still fall within the scope of the invention.

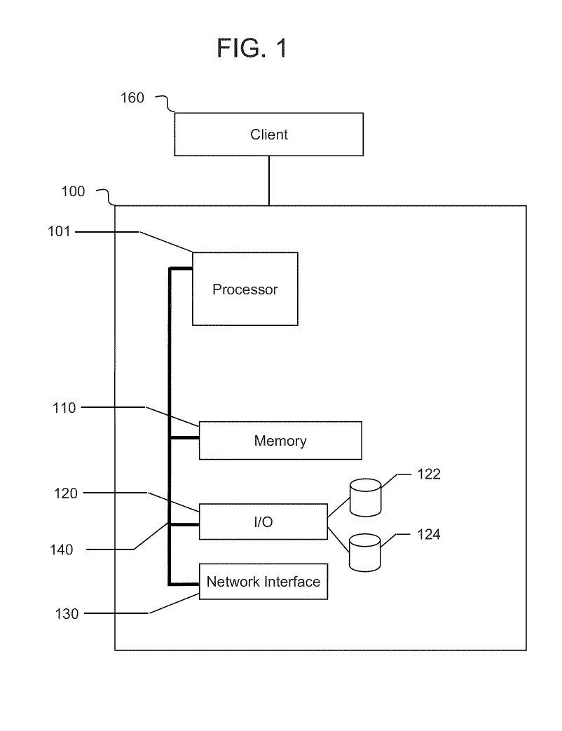

Referring to FIG. 1, a computer system 100 may include a processor 101, a memory 110, an input/output (I/O) interface 120, a network interface 130, and a data bus 140. The processor 101, the memory 110, the I/O interface 120, the network interface 130 may all communicate with one another through the data bus 140. While the elements listed above are illustrated in FIG. 1, it is to be understood that the computer system 100 may include many more computing components, such as a graphics module, a hard drive, a CD-ROM drive, DVD-ROM drive, tape drive, audio modules, universal serial bus (USB) ports, power supplies, cooling devices, heat sinks, or any other components that may be included in a computing device. The size and configuration of the computing system 100 may increase or decrease depending on computing model or customer need.

The processor 101 may be embodied by one or more processors if the computer system 100 is a multi-processor system. If the computer system has multiple processors, each processor may perform a different task, and each processor may be differently configured to accommodate their specific tasks. Alternatively, all of the processors may be constructed in the same manner, and one or more of the processors may be a spare processor included for redundancy. Additionally, one or more of the processors may be included to provide supervisory control over the other processors.

The memory 110 may include any computer storage medium, either volatile or non-volatile, removable or non-removable, such as FLASH, RAM, ROM, EEPROM, or any other storage medium that is configured to store information in any method or technology for information storage. The memory 110 is configured to store computer readable information, such as computer readable instructions and data. The memory 110 may be implemented to store program code to direct the processor 101 to process information and requests to or from other computing systems connected to the computer system 100 in any manner, such as through the network interface 130. The memory 110 may also be implemented to store program code to direct the processor 101 and the I/O interface 120 to present a user interface to a user.

The network interface 130 provides a network connection means and network protocols useful for sending and receiving information from and to other computer systems connected to the computer system 100. The network interface 130 may be connected to a network of any type, such as a local area network (LAN), a wide area network (WAN), or a wireless local area network (WLAN). The network interface 130 may communicate with other computer systems on the network through network protocols, such as TCP/IP, FTP, SSH, or any other network protocol. In addition, the network interface 130 may be connected to a network through any means including wireless means, such as Bluetooth, IEEE 802.11, and infrared, or wired means, such as Ethernet, firewire, and coaxial.

Peripheral devices 122 and 124 are connected to the I/O interface 120, and the peripheral devices 122 and 124 allow the computer system 100 to receive inputs from a user and output data and information to the user. The computer system 100 may include more or less than two peripheral devices. The peripheral devices 122 and 124 may include a mouse, a keyboard, a monitor, a printer, a scanner, a touch screen, buttons, or any other peripheral device useful for receiving data from a user and outputting data to a user. In the following example, the first peripheral device 122 is a display, and the second peripheral device 124 is a mouse. An operator of the computer system 100 may configure the computer system 100 using the peripheral devices 122, 124. Alternatively, a client computer 160 that is connected to the computer system 100 may configure the computer system 100. The client computer 160 may connect to the computer system 100 over a communications network.

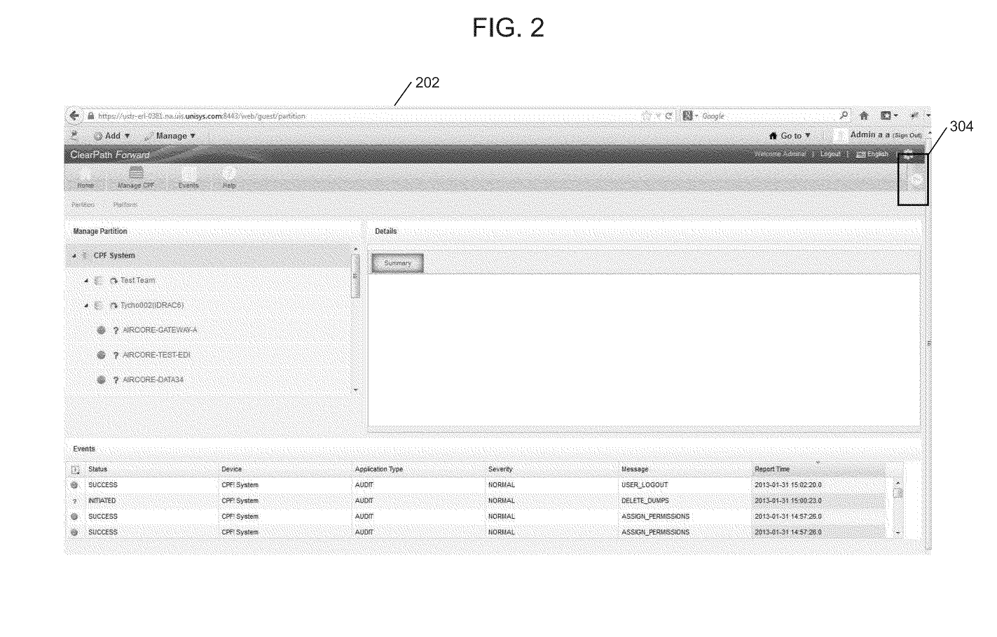

An operator may manage settings, configurations, or applications of the computer system 100 through a user interface. An exemplary computer system user interface is illustrated in FIGS. 2-4. An operator may also view status updates of the computer system 100 using the user interface or control operations and processes of the computer system 100. For example, the user interface may be a web interface displayed on the client computer 160, and an operator may change settings or view information about the computer system 100 by connecting to the computer system 100 remotely. The user interface may have a plurality of different buttons and information presented. While the user interface may generally be user-friendly, the user interface may present complex information or present many options for an operator to configure. As a result, an operator may not always understand what all of the information presented by the user interface means or what actions each button performs, especially if the operator is unfamiliar with the user interface. So, an operator may need to consult a help tool provided by the user interface to understand all of the functionality of the user interface and information presented by the user interface. The user interface includes a help tool to help a user learn the features of an application and how to control those features through the user interface.

The help tool of the exemplary embodiments presents help content that is context-sensitive. More specifically, the help tool displays information about the page being displayed by the user interface. When the computer system 100 receives a request to change the page being displayed by the user interface, the computer system 100 navigates to the requested page and updates the help content accordingly so that the help content references the requested page. As a result, help content displayed in the help tool always describes information and buttons of the currently displayed page. Thus, a user does not need to search for an appropriate help topic because the help tool displays the appropriate help content for the page being displayed by the user interface.

FIGS. 2-4 illustrate an exemplary presentation of the help tool. FIG. 2 illustrates a screen shot of a user interface 202 with a collapsed help tool. The help tool may collapse by default and remain collapsed until an operator activates an expand/collapse button 204. The user interface 202 is a web-based user interface. The exemplary user interface 202 presents options and information regarding the management of a computer system. For example, the user interface 202 allows an operator to manage partitions, create partitions, and see the status of running partitions, among many other features, options, and commands. While this particular user interface is shown for illustration purposes, the help tool of the exemplary embodiments may be applied to any user interface.

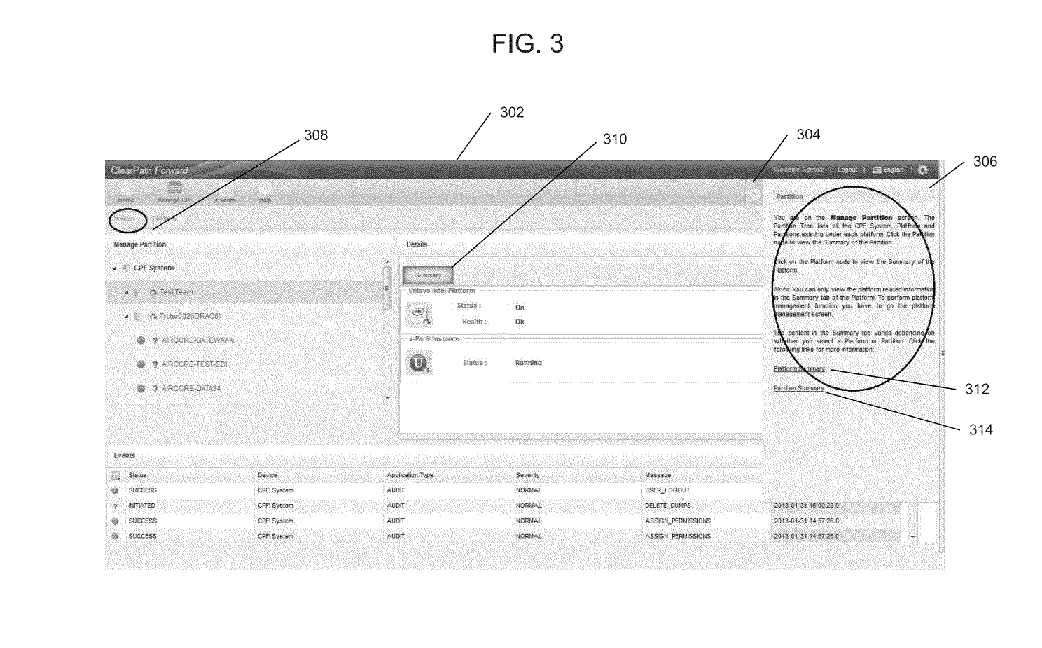

FIG. 3 illustrates an expanded help tool 306. The help tool 306 expands upon activation of the expand/collapse button 304. As shown in FIG. 3, the help tool 306 of the exemplary embodiments may be presented as an window frame that extends from one side of a computer screen. FIG. 3 illustrates that the user interface 302 displays the help tool 306 on the right side of the screen, but the user interface 302 may display the help tool 306 anywhere on the screen. The help tool 306 may collapse when an operator activates the expand/collapse button 304. The expand/collapse button 304 may slide out from one side of the user interface 302 with the expansion of the help tool 306. Alternatively, the help tool 306 may minimize or hide rather than collapse when the help tool 306 is not expanded, open, or maximized.

The help tool 306 presents help content about the current page displayed by the user interface 302. FIG. 3 illustrates a manage partition page 308, and the help tool 306 describes information that the manage partition page 308 displays. The help tool 306 also describes the summary tab 310. For example, the help tool recites that the summary tab 310 only displays platform related information, and no management functions can be performed from the summary tab 310. This information may help a user unfamiliar with the user interface 302 who may be looking for a way to perform management functions. Further, the help tool 306 directs the operator where to perform such functions.

In this particular help tool 306 content, the help tool 306 presents hyperlinks 312, 314 for additional information. Clicking one of these hyperlinks 312, 314 changes the information displayed by the help tool 306, but clicking one of the hyperlinks 312, 314 does not navigate the user interface 302 to another webpage, window, or tab. While the help tool 306 content illustrated in FIG. 3 contains hyperlinks, not all help tool 306 content pages contain hyperlinks for additional information.

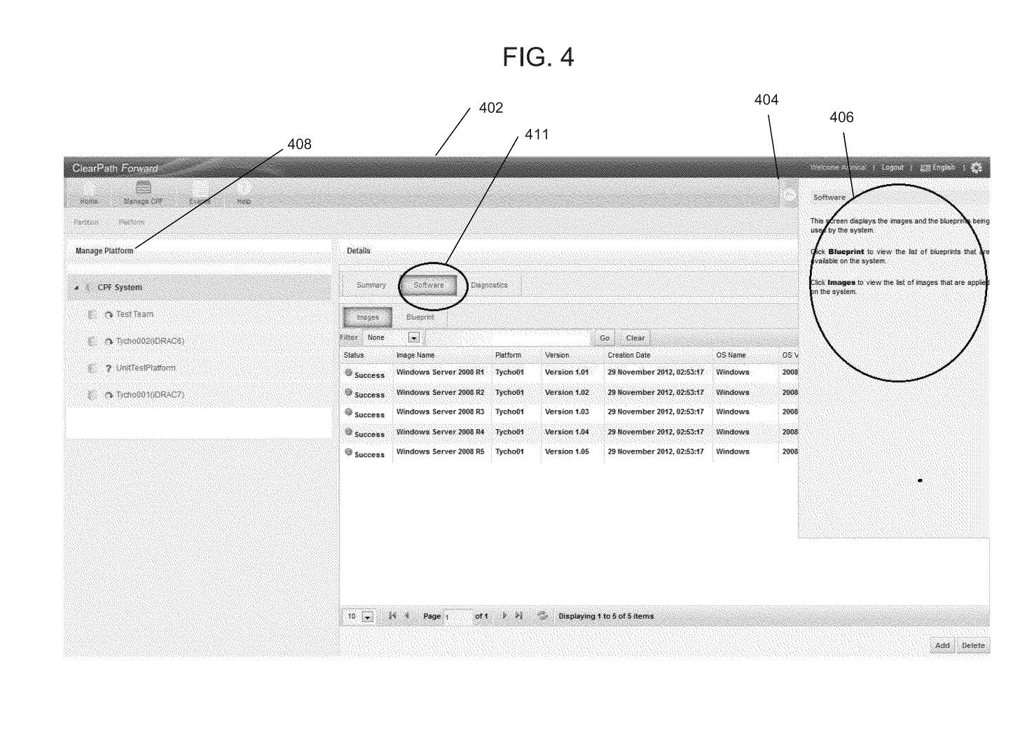

The information presented by the help tool 306 depends on the page displayed by the user interface 302. In FIG. 3, the user interface 302 displays a platform management page 308 containing a summary tab 310, which presents status information about the platform. If the operator navigates to another page, the content of the help tool 302 automatically changes upon activation of a hyperlink in the user interface 302 to navigate to a new page. FIG. 4 illustrates that the user interface 402 displays a software tab 411 within the manage platform page 408. Once the user interface displays the software tab 411, the help tool 406 content updates to display help content about the software tab 411. The help tool 406 updates the new help content when a new page is loaded by the user interface.

As shown through FIGS. 2-4, the help tool 406 presents help content that is relevant to the tab or page being displayed by the user interface 402. The help content updates upon the activation of a hyperlink or a button within the user interface 402. More specifically, the help content updates either when an operator activates a hyperlink within the help tool window 406 or a hyperlink or button within the user interface 402. The user interface 402 only displays the help tool 406 on the page when the operator activates the expand help tool button 404. So, the help tool 406 does not clutter the screen or annoy the user when the user does not need assistance from the help tool 406.

The dynamic help content presented by the help tool 406 may be very beneficial to a user unfamiliar with the user interface 402 or application. By simply navigating to different pages and tabs, an unfamiliar user may learn all of the functions and features of the user interface 402 by consulting the help tool 406. Thus, the help tool 406 may act as a tutorial service that trains a user unfamiliar with the user interface 402 as the user navigates around the user interface 402.

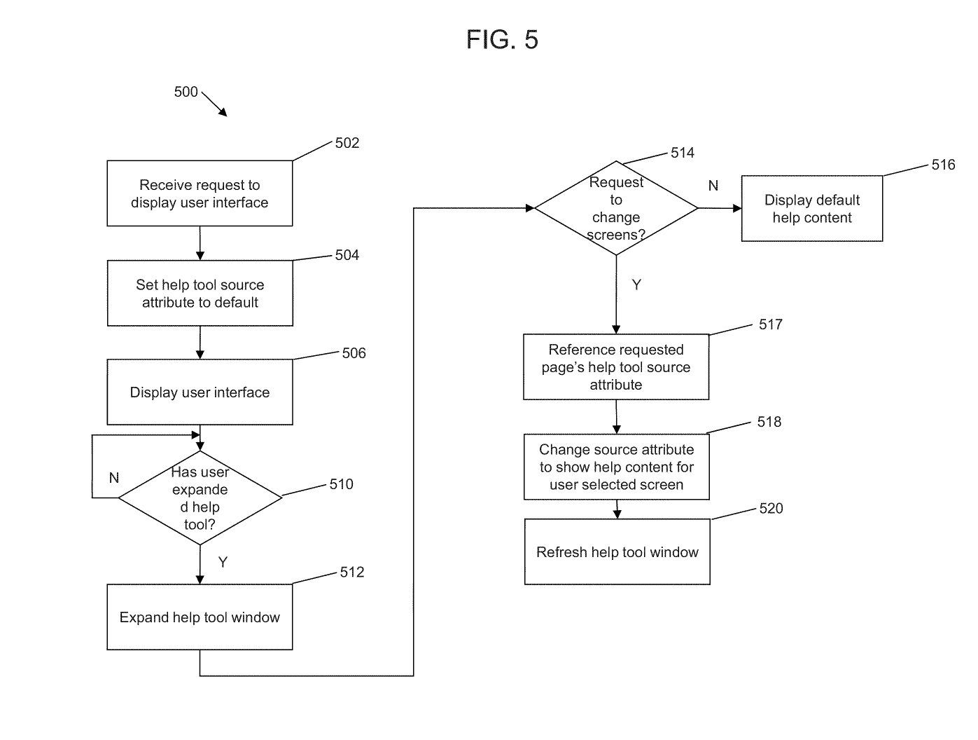

The help tool presents help content dynamically that is relevant to the current page or tab being displayed by the user interface. A method 500 for presenting dynamic help information is illustrated in FIG. 5. The method 500 begins at step 502, when a computer system receives a request to display a user interface. Such a request may be made through a web browser of a remote device connecting to the computer system, if the user interface is a web-based user interface. Alternatively, this request may be contained in a start application command. After the computer system receives the request, the computer system sets a help tool source attribute to a default value in step 504. The source attribute defines what help content is displayed by the help tool. The default value may be a welcome message or help content explaining options and information displayed by a main menu page. The help content may be written in HTML, and the source attribute defines which HTML help content the help tool displays. In other words, the source attribute may be an address of the help content HTML. After the help tool source attribute has been set to the default value, the computer system displays the user interface to the user in step 506.

As described above, the help tool is expandable and collapsible. So, when the computer system initially displays the user interface, the computer system may not initially display the help tool. In other words, the help tool may initially be in the collapsed state when the user interface launches and is first displayed to the user. Whether the help tool defaults to collapsed or expanded may be changed according to the preferences of the user. If the help tool defaults to the collapsed state, the computer system waits until the user activates the expand help tool button in step 510 before displaying any help content in the help tool. Once the user activates the expand help tool button, the user interface expands the help tool in step 512.

The computer system determines whether the user has requested to navigate to a different page in step 514. The computer system receives a command to navigate to a new page upon an activation of a button or hyperlink. The activation also serves as a notification to the computer system to update the help content window. If the user has not requested to navigate to another page, the help tool displays the default help content in step 516. Upon a request to navigate to another page, the computer system references the requested page's help tool source attribute in memory in step 517 and changes the help tool source attribute to the help content of the user selected page in step 518. After the source attribute has been changed, the help window is refreshed in step 520, and the help tool displays help content for the current page.

Each page may have its own help content HTML that is addressed by a specific source attribute. So, each page may have a respective source attribute and respective HTML help content. HTML is an exemplary language, but other languages may be used to write the help content. Each page has a source attribute stored in memory, and the computer system references the page's source attribute to change the help tool's source attribute when a new page is requested by the user.

Some pages may present similar information, and those similar pages may display similar help content. In such a situation, two pages may have the same source attribute.

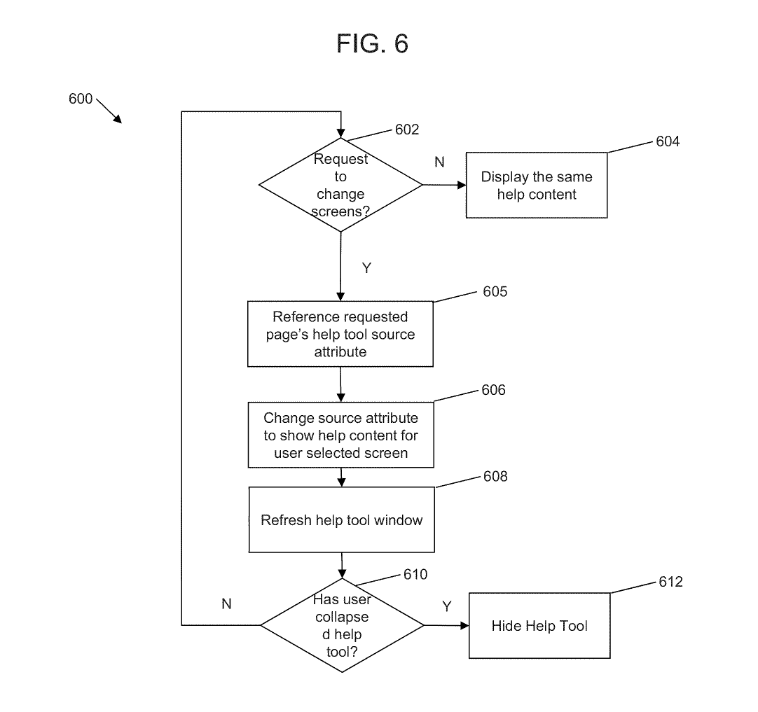

As long as the help tool remains expanded, the computer system will continue update the help content when a user navigates the user interface to a new page or tab. Thus, whenever the user changes the web-page, which signifies a change in help content topic, the help content updates with the loading of a new page. This method is illustrated in FIG. 6. The method 600 begins at step 602 where the computer system checks whether the user has requested to navigate to a different page. If the user has not requested to navigate to another page, the help tool does not change the help content in step 604. If the user has navigated to a different page, the computer system references the requested page's help tool source attribute in memory in step 605 and changes the help tool source attribute to the help content of the user selected page in step 606. After the source attribute has been changed, the computer system refreshes the help window in step 608, and the help tool displays help content for the current page. In step 610, the computer system checks whether the user requested to collapse the help tool. If so, the computer system hides the help tool in step 612. If not, the computer system repeats method 600 so that the help content is always displaying context sensitive help content. While step 610 is shown as being performed sequentially after refreshing the help content in the help tool, step 610 can be performed at anytime upon the activation of the collapse help tool button by the user.

As shown by the exemplary embodiments, a context-sensitive help tool that dynamically updates help content has been described. The help tool of the exemplary embodiments presents relevant help information to the user for the actions currently being performed by a user or information currently being viewed by the user. Because the help content is presented in this way, a user interface immediately displays relevant help information to the user seeking assistance. In other words, a user no longer has to search or find a relevant help topic because the help tool presents relevant help content automatically.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “displaying” or “receiving” or “referencing” or “changing” or “refreshing” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method for presenting help content for a user interface comprising:
displaying, by a computer, a user interface including a help tool window;
receiving, by a computer, a request to display a first user interface page on the user interface;
referencing, by a computer, a first help content address of help content for the first user interface page that is stored in memory;
changing, by a computer, a source attribute of the help tool window to the first help content address; and
refreshing, by a computer, the help tool window so that the help content for the first user interface page is displayed by the help tool window, wherein help content is based upon content of the first user interface page.

2. The method of claim 1, wherein the help content describes functionality of buttons or hyperlinks displayed by the first user interface page or information presented by the first user interface page after receiving the request to display the first user interface page.

3. The method of claim 1, further comprising:
receiving, by a computer, a request to display a second user interface page;
referencing, by a computer, a second help content address of help content for the second user interface page that is stored in the memory;
changing, by a computer, the source attribute of the help tool window to the second help content address; and
refreshing, by a computer, the help tool window so that the help content for the second user interface page is displayed by the help tool window.

4. The method of claim 3, wherein the help content describes functionality of buttons or hyperlinks displayed by the second user interface page or information presented by the second user interface page after receiving the request to display the second user interface page.

5. The method of claim 1, wherein the user interface presents an option to expand or collapse the help tool window.

6. The method of claim 5, wherein the help tool window is collapsed by default.

7. The method of claim 1, wherein the help tool window presents a hyperlink for additional information in the help tool window.

8. The method of claim 7, further comprising:
displaying, by a computer, the additional information within the help tool window upon receiving an activation of the hyperlink in the help tool window, wherein only information displayed by the help tool window changes upon receiving the activation of the hyperlink in the help tool window.

9. The method of claim 1, wherein the help tool window is displayed upon receiving a command to display the help tool window.

10. The method of claim 1, wherein the source attribute is set to a default address before receiving the request to display the first user interface page.

11. A computer system comprising:
a memory; and
a processor configured to:
display a user interface including a help tool window;
receive a request to display a first user interface page on the user interface;
reference a first help content address of help content for the first user interface page that is stored in the memory;
change a source attribute of the help tool window to the first help content address; and
refresh the help tool window so that the help content for the first user interface is displayed by the help tool window, wherein help content is based upon content of the first user interface page.

12. The computer system of claim 11, wherein the help content describes functionality of buttons or hyperlinks displayed by the first user interface page or information presented by the first user interface page after the processor receives the request to display the first user interface page.

13. The computer system of claim 11, wherein the processor is further configured to:
receive a request to display a second user interface page;
reference a second help content address of help content for the second user interface page that is stored in the memory;
change the source attribute of the help tool window to the second help content address; and
refresh the help tool window so that the help content for the second user interface is displayed by the help tool window.

14. The computer system of claim 13, wherein the help content describes functionality of buttons or hyperlinks displayed by the second user interface page or information presented by the second user interface page after the processor receives the request to display the second user interface page.

15. The computer system of claim 11, wherein the user interface presents an option to expand or collapse the help tool window.

16. The computer system of claim 15, wherein the help tool window is collapsed by default.

17. The computer system of claim 11, wherein the help tool window presents a hyperlink for additional information in the help tool window.

18. The computer system of claim 17, wherein the processor is further configured to:
display the additional information within the help tool window upon receiving an activation of the hyperlink in the help tool window, wherein only information displayed by the help tool window changes upon receiving the activation of the hyperlink in the help tool window.

19. The computer system of claim 11, wherein the help tool window is displayed upon receiving a command to display the help tool window.

20. The computer system of claim 11, wherein the source attribute is set to a default address before the processor receives the request to display the first user interface page.
